(19) United States
(12) Patent Application Publication
(10) Pub. No.: US 2013/0055153 A1
(43) Pub. Date: Feb. 28, 2013

(54) APPARATUS, SYSTEMS AND METHODS FOR PERFORMING ACTIONS AT A COMPUTING DEVICE

(71) Applicants: Jonathan Sherman, San Francisco, CA (US); David Kempe, Sunnyvale, CA (US)

(72) Inventors: Jonathan Sherman, San Francisco, CA (US); David Kempe, Sunnyvale, CA (US)

(21) Appl. No.: 13/220,304

(22) Filed: Aug. 29, 2011

(51) Int. Cl. G06F 3/048

(52) U.S. Cl. 715/810

(57) ABSTRACT

In one implementation, content is received via a user interface and a plurality of descriptors are output in response to the content. Each descriptor is associated with a target from a plurality of targets. A target from the plurality of targets is selected in response to user input, and the content is provided to the target.

### BACKGROUND

Many computing devices represent applications as icons in graphical user interfaces. Users of such computing devices navigate through various views of such graphical user interfaces to access icons associated with applications that allow the users to input content into these computing devices. As a result, users must first locate and activate an application, and then input content to that application.

### BRIEF DESCRIPTION OF THE DRAWINGS

FIGS. 1A-1E are illustrations of various views of a user interface, according to an implementation.

FIG. 2 is a flowchart of a process to perform an action using content and a target, according to an implementation.

FIG. 3 is a schematic block diagram of multi-target action system, according to an implementation.

FIG. 4 is a schematic block diagram of a computing device configured as a multi-target action system, according to an implementation.

FIG. 5 is a flowchart of a process to select a target for content, according to an implementation.

### DETAILED DESCRIPTION

Content input can be difficult on mobile computing devices such as smartphones and tablet or slate devices. Such computing devices often rely on touch-based input mechanisms and user interfaces that are based on icons. For example, a graphical user interface (GUI) of a mobile computing device can include icons related to applications, web pages, files such as image, document, video, or audio files at multiple views, screens, or areas among which a user can navigate using touch-based inputs such as gestures. Because the icons via which a user accesses applications, web pages, or files are often spread across the various views of the user interface, the user must often navigate multiple view of the user interface to access a desired application for content input.

Implementations discussed herein provide enhanced content input at computing devices. More specifically, for example, implementations discussed herein receive content from a user at an input component (e.g., a central or universal search input control) of a user interface, output a group of descriptors related to targets for the content to the user, and provide the content to a target related to a descriptor selected by the user. A target is an application (e.g., module hosted at a computing device), resource, or service (e.g., network service) that receives and operates on (e.g., manipulates, stores, displays, or transmits) content.

Accordingly, the user does not need to locate an icon related to the target using a user interface, activate the application, and then input the content to the target. Rather, the user inputs the content (or a portion thereof) at the input component of the user interface, selects a target (or action to be executed by a target on the content), and the content is provided to the target. Moreover, in some implementations, the target is also opened (e.g., activated) to allow the user to input additional content to the target. Furthermore, in some implementations, the input component can examine or interpret the content to determine which targets are compatible with the content (e.g., are configured or operable to operate or execute actions on or relative to the content). The group of descriptors can then be limited to descriptors related to targets compatible with the content.

As used herein, the singular forms “a,” “an,” and “the” include plural referents unless the context clearly dictates otherwise. Thus, for example, the term “descriptor” is intended to mean one or more descriptors or a combination of descriptors. Additionally, as used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software includes hardware only (i.e., a hardware element with no software elements), software hosted at hardware (e.g., software that is stored at a memory and executed or interpreted at a processor), or at hardware and software hosted at hardware.

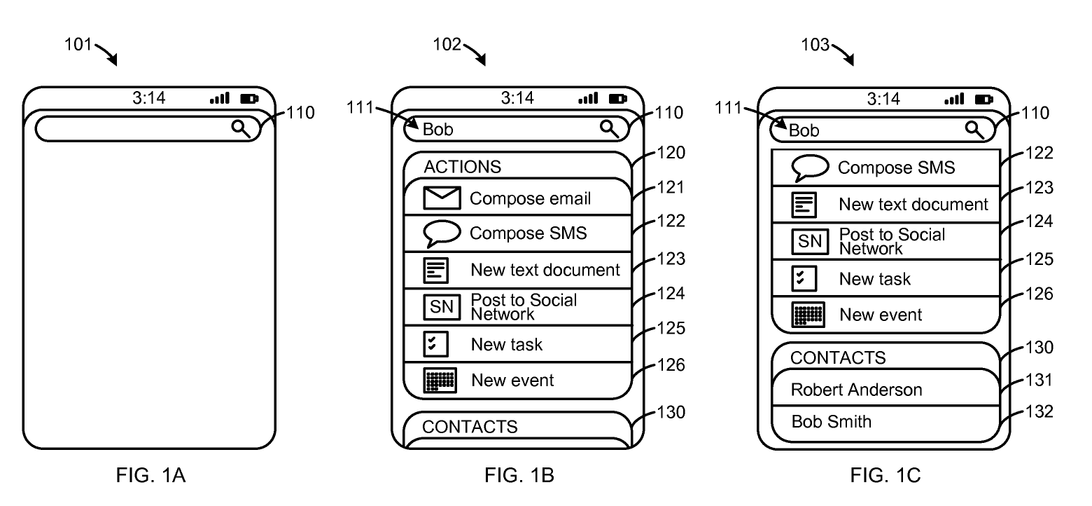

FIGS. 1A-1E are illustrations of various views of a user interface, according to an implementation. FIG. 1A illustrates view 101 of a user interface (e.g., an application or system that allows a user to interact with and/or input content to a mobile computing device) hosted at a mobile computing device (e.g., stored at a memory and executed at a processor of the mobile computing device). Input component 110 does not include content in view 101 illustrated in FIG. 1A. View 101 can be output at, for example, a display such as a touch-sensitive display of the mobile computing device. View 101 includes input component 110 at which a user can input (e.g., via an input device such as a keyboard or touch-sensitive or touch-based display) content. For example, a user can input content as textual data or text (e.g., letters, characters, symbols, and numbers) at input component 110.

FIGS. 1B and 1C illustrate views 102 and 103 of the user interface at which content 111 “Bob” has been input at input control 110. View 103 is a vertically scrolled version of view 102 to show contact section 130. As illustrated in FIGS. 1B and 1C, input component 110 is a universal or central search control (e.g., a control of the user interface at which a user can input text to initiate a search of files, applications, data, or information at the mobile computing device). That is, in addition to identifying and displaying descriptors of targets for the content input at input component 110, the user interface also identifies files, applications, data, or information at the mobile computing device that are related to content 111 and displays related descriptors. For example, files, applications, data, or information at the mobile computing device that include text that is similar to or matches text of content 111 can be identified.

Accordingly, in addition to descriptors related to targets for content 111, other descriptors can be displayed in response to content 111. For example, in response to content 111, descriptors 121-126 are identified in actions section 120 and descriptors 131 and 132 are identified in contact section 130 as related to content 111. Contacts section 130 includes descriptors 131 and 132 that are related to contact information stored at or accessible to the mobile computing device. Action section 120 includes descriptors related to (or for or of) targets to which content 111 can be provided. For example, descriptors 121-126 describe actions or operations that can be performed on, with, or using content 111 by providing content 111 to various targets.

As specific examples, descriptor 121 is related to an email application hosted at the mobile computing device, descriptor 122 is related to a short message service (SMS) application hosted at the mobile computing device, descriptor 123 is related to a word processing application hosted at the mobile computing device, descriptor 124 is related to a social networking application hosted at the mobile computing device, descriptor 125 is related to a task management application hosted at the mobile computing device, and descriptor 126 is related to a calendar application hosted at the mobile computing device. As illustrated in FIG. 1B, descriptors 121-126 include text and images (e.g., icons). In other implementations, descriptors can include text and not images, or images and not text.

A user can select a descriptor, and the content is provided to a target to execute the action for that descriptor. The action can include generating a document (e.g., a text document, a word processing document, a task or to-do item, or a file including contact information for a person or business) and inserting the content into that document, generating a message (e.g., an email message, an Instant Message (IM), an SMS message, or an MMS message) and inserting the content into that message, or generating an event (e.g., a calendar event, a meeting event, or an appointment) and inserting the content into that event. In other words, the action can include generating a document, message, or event based on the content.

For example, if the user selects descriptor 121 (e.g., touch a section of the display of the mobile computing device at which descriptor 121 is displayed), content 111 will be provided the email application, and a new email message including content 111 will be generated. Similarly, should the user select descriptor 122, content 111 will be provided the SMS application, and a new SMS message including content 111 will be generated. If the user selects descriptor 123, content 111 will be provided the word processing application, and a new document including content 111 will be generated. Similarly, if the user selects descriptor 125 or 126, content 111 will be provided to the task management application to generate a new task or to the calendar application to generate a new event (e.g., appointment, calendar event, meeting, etc.), respectively.

If the user selects descriptor 124, content 111 can be posted (e.g., sent or provided) to a network service related to or implementing a social network via the social networking application. A network service is an application, interface, or resource that is accessible via a communications network. For example, content 111 can be a status update for a user of the social network. The user interface provides content 111 to the social networking application, and the social networking application posts content 111 to a web or Internet interface of the social network. In some implementations, this posting occurs without additional input or action from the user.

Moreover, the social networking application can post content 111 without displaying a view of the social networking application at the user interface to the user. That is, the social networking application can post content 111 without changing views 102 or 103. In other implementations, the social networking application can display one or more view at the user interface to the user in response to receiving content 111 to allow the user to, for example, verify content 111, alter content 111, or to prompt the user to indicate whether the user would like to post content 111. In yet other implementations, a network service such as, for example, a network service of a social network can be a target, and the user interface provides content 111 to the network service via an API, protocol (e.g., Simple Object Access Protocol (SOAP) or Hypertext Transfer Protocol (HTTP)), or other communications.

In addition to descriptors illustrated in FIGS. 1B and 1C, additional descriptors can be displayed or output in response to content 111. For example, additional descriptors related to other targets such as messaging services or applications (e.g., multi-media messing service (MMS) services or applications), text-to-speech applications, or other applications can be displayed.

FIG. 1D illustrates view 104 of the user interface in which the user has input additional text to content 111. In some implementations, as illustrated in FIG. 1D, the user interface determines a context for content 111. For example, the user interface can determine from content 111 which targets are compatible with content 111 (e.g., able to receive content 111 or applicable to content 111), and display descriptors related to compatible targets and not display descriptors related to incompatible targets.

As illustrated in FIG. 1D, content 111 appears to have or be for a message context. More specifically, content 111 indicates that content 111 is a message to “Bob.” Accordingly, an email application, an SMS application, and a social networking application are likely compatible with content 111, and related descriptors 121, 122, and 124, respectively, are displayed. A word processing application is also likely compatible with content 111 (e.g., to compose a letter to “Bob”), and descriptor 123 is therefore displayed.

FIG. 1D illustrates selection of descriptor 121 (e.g., a user has touched a section of the display of the mobile computing device at which descriptor 121 is displayed), and FIG. 1E illustrates view 105 at which the email application has generated or opened new email message 140 in response to receiving the content after descriptor 121 was selected. Email message 140 includes recipient field 141, subject field 142, and body 143. Content 111 has been inserted into body 143 (e.g., content 111 was provided to the email application and the email application populated body 143 of email message 140 with content 111), and cursor 149 has been placed at recipient field 141 to allow the user to input an email address. In other implementations, cursor 149 can be placed in another field such as subject field 142 or body 143.

Thus, the user is able to generate a new email message by inputting content at input component 110 and selecting a descriptor related to a target or action for the content, rather than by navigating through the user interface to locate an icon related to the target (e.g., email application). Moreover, the content input to input component 110 is provided to the application (here, the email application) from input component 110 for use (e.g., addition, deletion, or other modification) by the user.

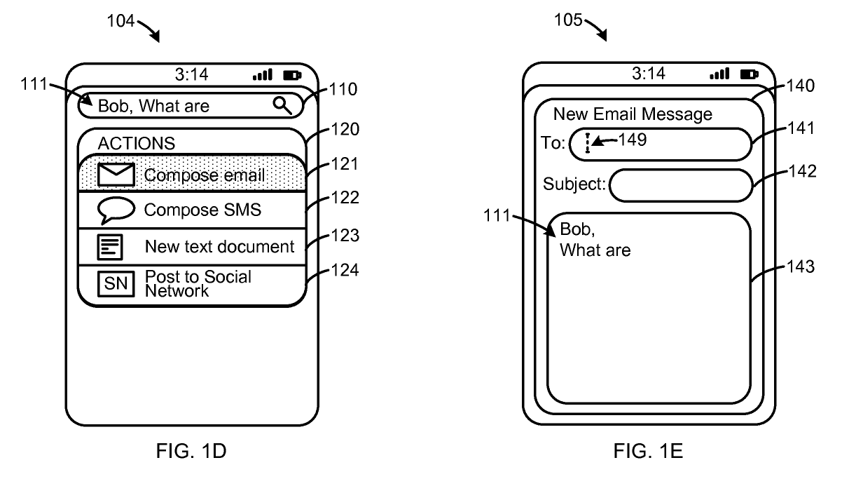

FIG. 2 is a flowchart of a process to perform an action using content and a target, according to an implementation. Process 200 can be implemented at, for example, a multi-target action system at a mobile computing device. As a more specific example, process 200 can be implemented at an operating system, an application, or a service including a graphical user interface at a mobile computing device.

Content is received at block 210. For example, content such as text can be input by a user at a user interface or an input component of a user interface. Available actions for the content are then identified at block 220. In some implementations, each action can be related to a target from a group of targets that are registered with a multi-target action system implementing process 200.

As an example, targets that operate on (or execute actions relative to) the content can be identified at a target registry of a multi-target action system that includes information related to targets that have registered with the multi-target action system. For example, targets can register by informing the multi-target action system via an application programming interface (API) or other registration mechanism that they are configured or operable to receive content via an API, a group of APIs, message passing mechanisms, or other mechanisms and to perform an action relative to the content. The multi-target action system stores information related to each target (e.g., a name of or reference to each target) at the target registry, and accesses the target registry at block 220 to identify available actions (e.g., actions executed by registered targets). Furthermore, in some implementations, such targets can provide a descriptor to the multi-target action system as part of registering that will be displayed to identify or describe the target or an action performed on content by the target. Such descriptors can also be stored at the target registry and accessed at block 220.

Descriptors or other information related to actions (or the targets that perform those actions) identified at block 220 are output at block 230. For example, the descriptors can be displayed at a graphical user interface of a mobile computing device. Alternatively, for example, the descriptors can be output at a command line interface (CLI) or other text-based interface of a computing device.

In some implementations, content received at block 210 can be provided to targets associated with actions identified at block 220 to generate descriptors for those actions at block 230. Said differently, content can be provided to targets associated with available actions, and the descriptors for the actions can depend on output or feedback based on the content from the targets to the multi-target action system implementing process 200. As a specific example, the content can be “3+4,” and one of the actions identified at block 220 can be a calculate action associated with a calculator application. The content can be provided to the calculator application to generate a sum of 7. This sum is then provided to the multi-target action system implementing process 200 by the calculator application (e.g., via an API or message passing mechanism), and is included in the descriptor for the calculate action output at block 230. For example, the descriptor can include an icon related to the calculator application, and a text string of “3+4=7.” The user can then select that descriptor to activate the calculator application, or can move to a different view of the user interface.

After block 240, process 200 then waits at block 240 for user input. If the user input relative to a descriptor output at block 230 is received (or detected) at block 240, process 200 proceeds to block 250. User input relative to a descriptor is user input that selects or identifies a descriptor. For example, if the descriptors are output (e.g., displayed) at a graphical user interface, the user input can be a mouse click event or touch-event at or in close proximity to a descriptor. Alternatively, for example, if the descriptors are output at a text-based interface, input relative to a descriptor can be input including an identification number or other identifier that identifies that descriptor from the other descriptors.

The target associated with the action of the descriptor relative to which the user input was received (or detected) at block 240 is selected for the content at block 250. In other words, the target associated with the action of that descriptor is selected to receive the content. The action is then performed using the content and the target at block 260 by providing the content to the target related to that action. As a specific example, the target can be an application (e.g., instructions, code, or logic hosted at a processor) which implements or can receive content via an API or message passing mechanism. The action is performed using the content and the target by providing the content to the target via the API or message passing mechanism. That is, the multi-target action system implementing process 200 performs the action using the content and the target by providing the content to the action related to or registered for the action, and the target then executes the action.

Returning to block 240, if the user input is not relative to a descriptor, process 200 completes. For example, the user input can be related to an exit command (or control) or a clear content command of a user interface. Accordingly, process 200 can exit or return to block 210, respectively, in response to the user input.

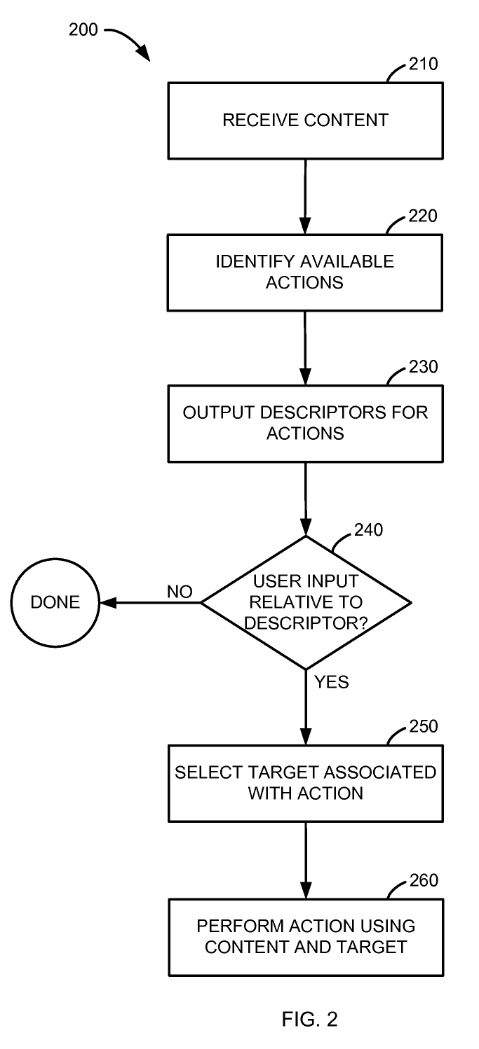

FIG. 3 is a schematic block diagram of multi-target action system, according to an implementation. Multi-target action system 300 receives content at input module 310, outputs descriptors for targets and/or related actions at description module 330, and provides the content to a target selected in response to user input relative to a descriptor for that target at action module 340 to allow the target execute an action on the content. Although various modules are illustrated and discussed in relation to FIG. 3 and other example implementations, other combinations or sub-combinations of modules can be included within other implementations. Said differently, although the modules illustrated in FIG. 3 and discussed in other example implementations perform specific functionalities in the examples discussed herein, these and other functionalities can be accomplished at different modules or at combinations of modules. For example, two or more modules illustrated and/or discussed as separate can be combined into a module that performs the functionalities discussed in relation to the two modules. As another example, functionalities performed at one module as discussed in relation to these examples can be performed at a different module or different modules.

Input module 310 receives content and is in communication with description module 330 to provide content to description module 330. For example, input module 310 receives user input at a user interface as content. Input module 310 can be associated with, for example, an input component of a graphical user interface to receive content via that input component.

Target registry 320 includes information such as identifiers and/or descriptors of targets accessible to multi-target action system 300. That is, information related to targets registered with multi-target action system 300 to receive content (or registered targets) is stored at target registry 320. In some implementations, entries of target registry 320 for each target can include information such as a location, a path, a network address, or security information (e.g., encryption keys, ciphers, or services) that can be used to communicate with (e.g., provide content to) that target. As illustrated in FIG. 2, target registry 320 includes entries 321, 322, and 323 that include information related to targets 391, 392, and 393, respectively.

In some implementations, in addition to identifiers and descriptors, target registry 320 includes information related to the capabilities of registered targets. For example, target registry 320 can include information that identifies or describes the contexts, types, or classes of content (e.g., content for a document, content for a message, content for a social network, content for an event, content for a task, etc.) that targets can receive and/or on which targets are configured or operable to perform actions. Targets can provide this information to target registry via, for example, an API used to register with multi-target action system 300 (or target registry 320).

Description module 330 receives content from input module 310 and communicates with target registry 320 to access descriptors of targets (or actions performed by targets) available for the content. Description module 330 then outputs (e.g., displays) the descriptors available for the content, and selects a target to receive the content based on user input. In some implementations, description module 330 accesses and outputs a descriptor for each target registered at target registry 320 in response to content from input module 310. In other words, in some implementations, description module 330 does not determine a context, type, or class of content before outputting descriptors of targets (or actions performed by targets).

In other implementations, description module 330 parses or analyzes content to determine a context, type, or class of the content, and displays only those descriptors for targets that are compatible with that context, type, or class of content. For example, description module 330 can request information related to targets compatible with that context, type, or class of content from target registry 320, and can output descriptors from that information. Alternatively, for example, description module 220 can filter information related to targets received from target registry 320 based on that context, type, or class of content, and can output descriptors for targets compatible with that context, type, or class of content from that information.

After the descriptors are output, description module 330 provides the content to action module 340. Action module 340 then waits for user input relative to a descriptor. If user input is received or detected relative to a descriptor, action module 340 selects the target related to that descriptor to receive the content. In other words, action module 340 designates the target associated with a descriptor selected by a user as the target to receive the content. That target will then perform an action such as an action described by a descriptor of the target on the content.

After selecting the target to receive the content, action module 340 provides the content to the target. As an example, action module 340 provides the content to the target using an API or other messaging mechanism. In some implementations, as illustrated in FIG. 3, action module 340 accesses an entry of target registry 320 that includes information related to providing the content to the target. For example, action module 340 can access such information to determine a location or path of the target. Alternatively, for example, action module 340 can access such information to determine a network address, network location, or network name or identifier of the target. As yet another example, action module 340 can access such information to determine an encryption key, a cipher, or a security service used to provide the content to the target. Accordingly, action module 340 can provide content to the target using, for example, a path of the target, a network address of the target, or a security service.

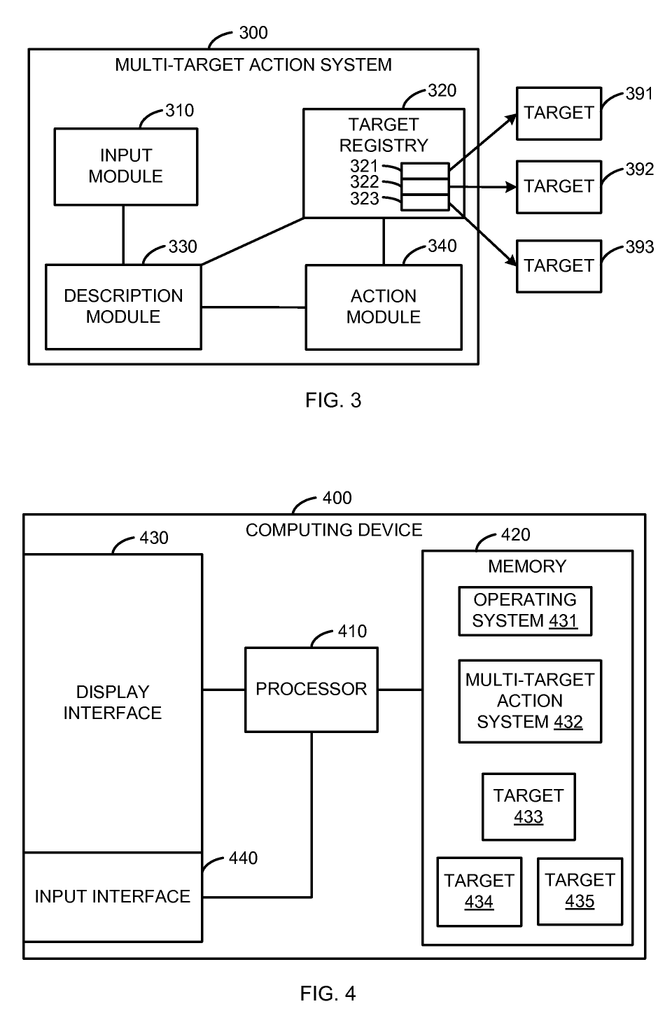

In some implementations, a multi-target action system is implemented at a computing device. FIG. 4, for example, is a schematic block diagram of a computing device configured as a multi-target action system, according to an implementation. More specifically, for example, as illustrated in FIG. 4, computing device 400 hosts (or stores and executes) multi-target action system 432 at processor 410, causing processor 410 (or computing device 400) to function or operate as a multi-target action system. Computing device 400 includes processor 410, memory 420, display interface 430, and input interface 440.

Processor 410 is any combination of hardware and software that executes or interprets instructions, codes, or signals. For example, processor 410 can be a microprocessor, an application-specific integrated circuit (ASIC), a distributed processor such as a cluster or network of processors or computing devices, a multi-core or multi-processor processor, or a virtual machine.

Memory 420 is a non-transitory processor-readable medium that stores instructions, codes, data, or other information. For example, memory 420 can be a volatile random access memory (RAM), a persistent data store such as a hard disk drive or a solid-state drive, or a combination thereof or other memories. Other examples of memory (or processor-readable medium) 420 include a compact disc (CD), a digital video disc (DVD), a Secure Digital™ (SD) card, a MultiMediaCard (MMC) card, or a CompactFlash™ (CF) card. In some implementations, memory 420 includes two or more different processor-readable media. Furthermore, memory 420 can be integrated with processor 410, separate from processor 410, or external to computing device 400.

As illustrated in FIG. 4, memory 420 includes operating system 431, multi-target action system 432, target 433, target 434, and target 435. Operating system 431, multi-target action system 432, target 433, target 434, and target 435 are each instructions or code that—when executed at processor 410—cause processor 410 to perform operations that implement, respectively, a multi-target action system such as multi-target action system 300 discussed above in relation to FIG. 3. Said differently, operating system 431 and multi-target action system 432 are hosted at computing device 400. For example, the instructions or codes of multi-target action system 432 can cause processor 410 to receive content via a user interface implemented at operating system 431 and provide that content to target 434.

In some implementations, computing device 400 can be a virtualized computing device. For example, computing device 400 can be hosted as a virtual machine at a computing server. Moreover, in some implementations, computing device 400 can be a virtualized computing appliance, and operating system 431 is a minimal or just-enough operating system to support (e.g., provide services such as a communications stack and access to components of computing device 400) multi-target action system 432.

Multi-target action system 432 can be accessed or installed at computing device 400 from a variety of memories or processor-readable media. For example, computing device 400 can access multi-target action system 432 at a remote processor-readable medium or installation service via a communications interface module (e.g., a cellular network interface or a wireless local area network), and multi-target action system 432 can be installed from that processor-readable medium or installation service. As a specific example, computing device 400 can be a thin client that accesses operating system 431 and multi-target action system 432 during a boot sequence via a communications network. Alternatively, for example, multi-target action system 432 can be accessed or installed at computing device 400 from another computing device. More specifically, in some implementations, multi-target action system 432 can be transferred to computing device 400 from another computing device via a Universal Serial Bus™ (USB) interface, FireWire™ interface, or a wireless interface such as an inductive data transfer interface. Moreover, such installations can utilize either a push model (e.g., multi-target action system 432 is pushed from a processor-readable medium or installation service to computing device 400) or a pull model (e.g., multi-target action system 432 is pulled from a processor-readable medium or installation service to computing device 400).

As another example, computing device 400 can include (not illustrated in FIG. 4) a processor-readable medium access device (e.g., a CD, DVD, SD, MMC, or CF drive or reader), and access multi-target action system 432 at a processor-readable medium via that processor-readable medium access device. As a more specific example, the processor-readable medium access device can be a SD card reader at which an SD card including an installation package for multi-target action system 432 is accessible. The installation package can be executed or interpreted at processor 410 to install multi-target action system 432 at computing device 400 (e.g., at memory 420). Computing device 400 can then host or execute multi-target action system 432.

Display interface 430 can be accessed by multi-target action system 432 (e.g., via operating system 431) to display descriptors for targets (or actions related to targets) in response to content input at input interface 440. Display interface 430 is a module that generates signals that represent information. For example, a computer display can be connected to display interface 430 to display views of a user interface. In some implementations, display interface 430 includes a display, such as a display at a mobile computing device. Input interface 440 is a module via which input from a user (or user input) can be received at computing device 400. For example, input interface 440 can include a PS/2 interface, USB interface, a keyboard, a trackpad, or trackball.

As illustrated in FIG. 4, in some implementations, display interface 430 and input interface 440 can be integrated one with another. For example, display interface 430 and input interface 440 can include a touch- or proximity-sensitive display at which operating system 431 can output information such as descriptors for targets provided by multi-target action system 432, and at which a user of computing device 400 can input information such as content by touching the display.

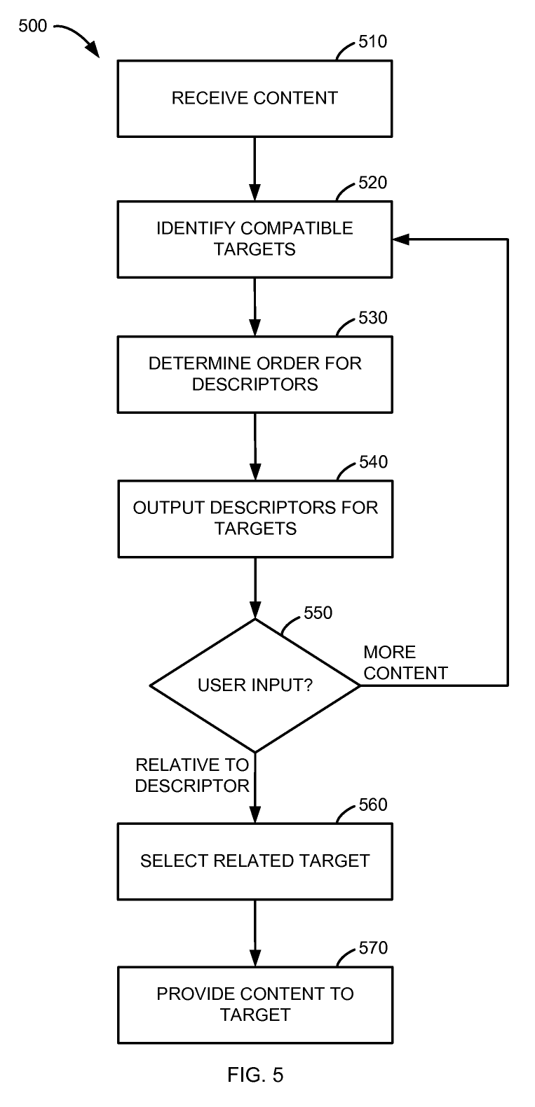

FIG. 5 is a flowchart of a process to select a target for content, according to an implementation. Content is received at block 510, for example, as user input at a user interface. Targets that are compatible with the content (e.g., are configured or operable to execute an action on or relative to the content) are then identified at block 520. For example, a context, type, or class of the content can be determined by parsing and/or analyzing the content based on words, phrases, capitalization, punctuation, or other properties or characteristics of the content. As a specific example, text content can be analyzed to determine whether the text content is for a message (i.e., the content is of a message type such as a salutation or a name of a contact followed by a comma), is general text (i.e., the content is of a generic text content type), is for an event (i.e., is of an event type such as a date or time), or is a number (i.e., is of a numeric type such as an address, telephone number, or group of numbers and symbols that can be calculated).

After a context, type, or class of the content is determined, targets that handle (e.g., are configured or operable to receive and operate or execute an action on or relative to) content in that context or of that type or class are identified. Information related to those targets such as descriptors of those targets or the actions executed on the content by those targets can be accessed at a target registry. That is, the target registry can describe the context, type, or class of the content which targets are registered to handle, and information for the targets that are registered to handle content in that context or of that type or class can be accessed at the target registry. Accordingly, the target registry can be accessed to identify targets that handle (or are compatible with) content in that context or of that type or class.

An order for the descriptors of the compatible targets is then determined at block 530, and the descriptors are output at block 540. The order can be defined by, for example, user preferences (or preference settings) stored at a multi-target action system or a mobile computing device hosting a multi-target action system, patterns of use of targets, and/or context, type, or class of content. As a specific example, a user can specify a relative order among the targets at a preference settings view of a user interface, and descriptors of targets are output at a display of a mobile computing device according to that order.

As another example, a multi-target action system or a mobile computing device hosting a multi-target action system can observe or learn usage or access patterns for the targets, and define an order based on those patterns. More specifically, for example, a multi-target action system implementing process 500 can record a relative frequency with which various targets are used (e.g., content is provided to those targets in response to user input), and descriptors of the targets can be output in an order based on frequency of use (e.g., descriptors for the most frequently used targets are output before descriptors of less frequently used targets).

As yet another example, descriptors of targets that handle one type of content can be output before descriptors of targets that handle other types of content. For example, the context, type, or class of the content can be determined as a probability at block 520. Thus, a precise context, type, or class of the content is not determined at block 520. Rather, probabilities that the content is in or of each of a group of contexts, types, or classes are assigned to those contexts, types, or classes. The descriptions of the targets can then be output in an order based on those probabilities. More specifically, for example, descriptors of targets that handle a context, type, or class of context assigned a high probability are output before targets that handle a context, type, or class of context assigned a low probability.

Process then waits at block 550 for user input. If additional content is received, process 500 returns to block 510 at which compatible targets are identified in view of the additional content. For example, the context, type, or class of the content can have changed from that of a previous iteration of block 520 based on the additional content received at block 550. Accordingly, the descriptors and/or order thereof output at block 540 can change at different iterations of blocks 520, 530, 540, and 550. In some implementations, such iterative refinement of the descriptors and/or order thereof output at block 540 can narrow the number of descriptors output and/or cause descriptors of targets most relevant to the content to be output before descriptors of targets less relevant to the content. Thus, as the user inputs additional content, the descriptors output can be more refined or specific with respect to the content.

Returning to block 550, if the user input is relative to a descriptor, the target associated with that descriptor is selected (e.g., designated) as the target for the content at block 560, and the content is provided to the target at block 570. The target can then execute an action using the content.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. As another example, functionalities discussed above in relation to specific modules or elements can be included at different modules, engines, or elements in other implementations. Furthermore, it should be understood that the systems, apparatus, and methods described herein can include various combinations and/or sub-combinations of the components and/or features of the different implementations described. Thus, features described with reference to one or more implementations can be combined with other implementations described herein.

What is claimed is:

1. A processor-readable medium storing code representing instructions that when executed at a processor cause the processor to:
receive content via a user interface;
output a plurality of descriptors in response to receiving the content, each descriptor associated with a target from a plurality of targets;
select a target from the plurality of targets in response to user input; and
provide the content to the target.

2. The processor-readable medium of claim 1, further storing code representing instructions that when executed at a processor cause the processor to identify the plurality of targets based on the content.

3. The processor-readable medium of claim 1, wherein the plurality of targets are compatible with the content.

4. The processor-readable medium of claim 1, further storing code representing instructions that when executed at a processor cause the processor to determine that the plurality of targets are compatible with the content.

5. The processor-readable medium of claim 1, wherein the target from the plurality of targets is selected in response to user input relative to the descriptor associated with the target.

6. The processor-readable medium of claim 1, wherein the content is textual data.

7. The processor-readable medium of claim 1, wherein the target is an application hosted at the processor.

8. The processor-readable medium of claim 1, wherein the target is a network service.

9. The processor-readable medium of claim 1, wherein the plurality of descriptors are output according to an order based on a preference setting.

10. The processor-readable medium of claim 1, wherein the plurality of descriptors are output according to an order based on the content.

11. A method to perform an action using content and a target, comprising:
receiving the content via a user interface;
displaying a plurality of descriptors in response to the receiving, each descriptor identifies an action from a plurality of actions for the content;
selecting the target from a target registry in response to user input relative to a descriptor, the target associated with the action identified by the descriptor; and
performing the action identified by the descriptor using the content and the target.

12. The method of claim 11, wherein the action includes posting the content to a network service.

13. The method of claim 11, wherein the action includes inserting the content into a message.

14. The method of claim 11, wherein the action includes inserting the content into a document.

15. The method of claim 11, wherein the action includes inserting the content into an event.

16. The method of claim 11, further comprising:
determining an order for the plurality of descriptors based on a preference setting, the plurality of descriptors are displayed according to the order.

17. The method of claim 11, further comprising:
determining an order for the plurality of descriptors based on the content, the plurality of descriptors are displayed according to the order.

18. A multi-target action system, comprising:
an input module to receive content in response to user input;
a target registry to store information associated with a plurality of targets, each target from the plurality of targets is registered to perform an action on the content;
a description module to output a plurality of descriptors in response to a signal from the input module, each descriptor associated with an action; and
an action module to select a target from the target registry based on a selected descriptor and to provide the content to the target, the target operable to perform the action associated with the selected descriptor on the content.

19. The multi-target action system of claim 18, wherein the description module determines that the action associated with each descriptor is compatible with the content before outputting the plurality of descriptors.

20. The multi-target action system of claim 18, wherein the description module accesses the plurality of descriptors at the target registry.
